(19) United States
(12) Patent Application Publication
(10) Pub. No.: US 2012/0227712 A1
(43) Pub. Date: Sep. 13, 2012

(54) Vaporize fuel for gasoline engines

(76) Inventor: Jason Jay Varnum, Saint Petersburg, FL (US)

(21) Appl. No.: 12/932,829

(22) Filed: Mar. 8, 2011

(51) Int. Cl. F02M 33/02

(52) U.S. Cl. 123/518

(57) ABSTRACT

Vaporize, in its simplest form, is gasoline vapors used to fuel a gasoline powered engine.

### CROSS-REFERENCE TO RELATED APPLICATIONS

Not Applicable

### FEDERALLY SPONSORED RESEARCH

Not Applicable

### SEQUENCE LISTING OR PROGRAM

Not Applicable

### BACKGROUND

1. Field

This application is a new way to fuel a gasoline powered engine.

2. Prior Art

Gasoline is a petroleum-derived liquid mixture which is primarily used as a fuel in internal combustion engines. It consists mostly of aliphatic hydrocarbons obtained by the fractional distillation of petroleum, enhanced with iso-octane or the aromatic hydrocarbons toluene and benzene to increase its octane rating. Some mixtures also contain significant quantities of ethanol as a partial alternative fuel.

The vehicle's system has a FUEL EVAPORATIVE SYSTEM (EVAP). The EVAP system allows for proper fuel system ventilation while preventing fuel vapors from reaching the atmosphere. This means that vapors must be caught and stored while the engine is off, which is when most fuel evaporation occurs. When the engine is started, these fuel vapors can be removed from storage and burned.

Evaporative emissions are the result of gasoline vapors escaping from the vehicle's fuel system. Since 1971 (1970 in California), all U.S. vehicles have had fully sealed fuel systems that do not vent directly to the atmosphere; mandates for systems of this type appeared contemporaneously in other jurisdictions. In a typical system, vapors from the fuel tank and carburetor bowl vent (on carbureted vehicles) are ducted to canisters containing activated carbon. The vapors are adsorbed within the canister, and during certain engine operational modes fresh air is drawn through the canister, pulling the vapor into the engine, where it burns.

This system is designed to not let the vapors escape into the atmosphere. But the one thing that should be understood here is the engine does not use this system to run, it uses gasoline in a (liquid mixture) solid state.

### SUMMARY

The specifications of Vaporize are simple. First you have gasoline in a gasoline tank. Gasoline is constantly evaporating (evaporate: To pass off in vapor). The gasoline vapors are highly ignitable (ignite: To catch fire). I use the vapors of the gasoline, not the gasoline itself to run the engine. Engines have always run on gasoline in it's (liquid mixture) solid state, not gasoline vapors.

Engines using Gasoline vapors, instead of gasoline in a (liquid mixture) solid state, will get far better fuel economy, and the emissions will be cleaner. In my utility patent drawings, I show how the gasoline vapors from the gasoline tank will run any gasoline powered engine.

### DRAWINGS

### Figures

In the drawings, closely related figures have the same number but different alphabetic suffixes.

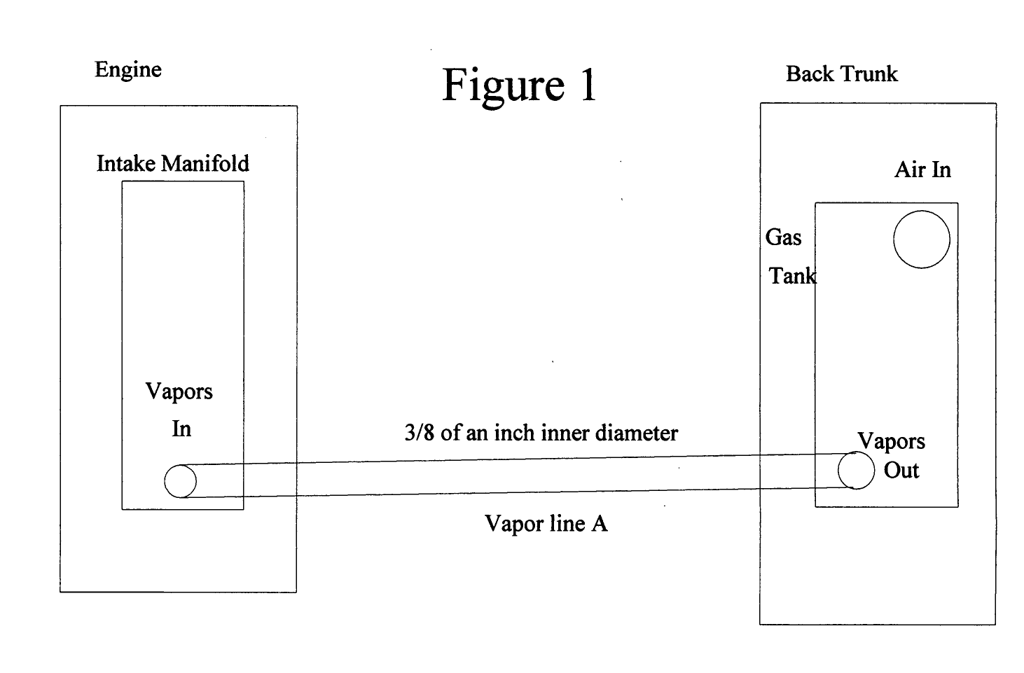

FIG. 1—Embodiment drawing with one vapor line.

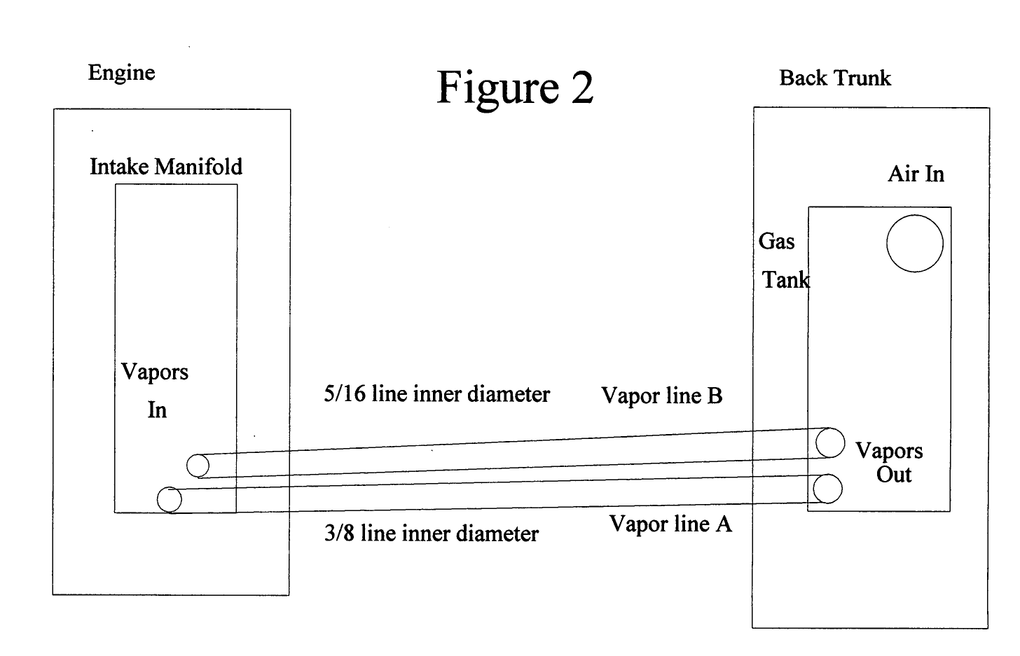

FIG. 2—Embodiment drawing with two vapor lines.

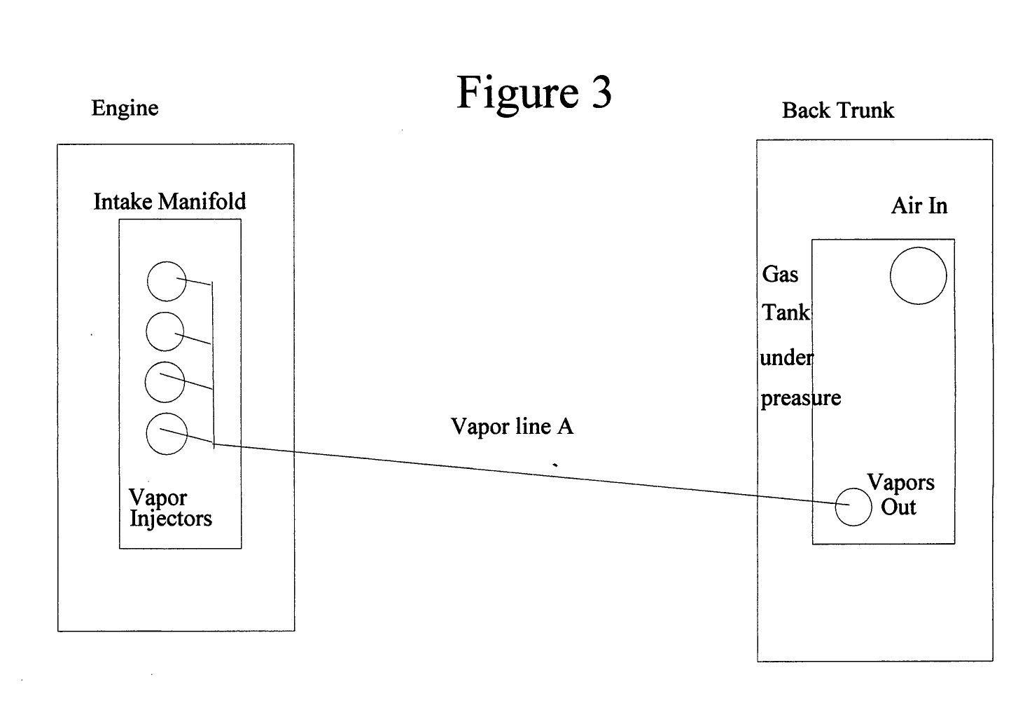

FIG. 3—Embodiment drawing with vapors under pressure and vapor injectors.

### REFERENCE NUMERALS

1 Engine—Represents a gasoline powered engine.
2 Intake Manifold—Represents an intake manifold.
3 Vapors In—Represents a port on the intake manifold, to accommodate vapor line A, for the vapors to enter to fuel the engine.
3-A Vapors In A&B—Represents ports A&B on intake manifold, to accommodate vapor line A&B, for the vapors to enter to fuel the engine.
3-B Vapor Injectors—Represents a vapor injector for each cylinder of the engine.
4 Back Trunk—Represents a holding space for a gasoline tank.
5 Gasoline Tank—Represents a tank that holds gasoline that will create vapors.
5-A Gasoline Tank under pressure—Represents a tank that holds gasoline under pressure.
6 Vapors out—Represents a port on the gasoline tank for vapors to exit towards the engine.
6-A Vapors Out A&B—Represents ports A&B on the gasoline tank for vapors to exit towards the engine.
7 Air In—Represents a port on the gasoline tank to allow fresh air in to replace the vapor filled air leaving the gasoline tank as fuel.
8 Vapor Line A—Represents the vapor line from gasoline tank, ⅜ of an inch inner diameter, to the intake manifold.
8-A Vapor lines A&B—Represents the two vapor lines, ⅜& 5/16 of an inch inner diameters, from the gasoline tank to the intake manifold.

### DETAILED DESCRIPTIONS

### FIGS. 1, 2, and 3—Embodiments

One embodiment of Vaporize is illustrated in FIG. 1. This embodiment illustrates a regular gasoline engine running on gasoline vapors supplied through a line or hose that could be made of any material that can transport gasoline vapors. The regular gasoline tank supplies the gasoline vapors, emitting from the gasoline, to the line or hose supplying the engine with fuel vapors. The regular gasoline tank has a fresh air inlet to replenish the gasoline vapor filled air leaving the gasoline tank.

### Operation—FIG. 1

This embodiment will run the engine, at idle, for as long and as often as needed. The engine will also start just using vapors in this illustration.

Another embodiment of Vaporize is illustrated in FIG. 2. This embodiment illustrates a regular gasoline engine running on gasoline vapors supplied through two lines or hoses that could be made of any material that can transport gasoline vapors. The regular gasoline tank supplies the gasoline vapors, emitting from the gasoline, to the lines or hoses supplying the engine with fuel vapors. The regular gasoline tank has a fresh air inlet to replenish the gasoline vapor filled air leaving the gasoline tank.

### Operation—FIG. 2

This embodiment will run the engine at idle, and will accelerate up to sixty five miles per hour, for as long and as often as needed. The engine will also start just using vapors in this illustration.

The third embodiment of Vaporize is illustrated in FIG. 3. This embodiment illustrates a regular gasoline engine running on gasoline vapors supplied by vapor injectors under pressure through a line or hose that could be made of any material that can transport gasoline vapors and handle pressure. The gasoline tank supplies the gasoline vapors, emitting from the gasoline, under pressure to the lines or hoses supplying the engine's vapor injectors with fuel vapors. The gasoline tank has a fresh air inlet to replenish the gasoline vapor filled air leaving the gasoline tank.

### Operation—FIG. 3

This embodiment will run the engine as well as it runs on gasoline in a (liquid mixture) solid state.

### Conclusion, Ramifications, and Scope

Accordingly, the reader will see that Vaporize, with these various embodiments; can be used with any gasoline powered engine easily and conveniently. In addition, gasoline vapors are the leanest byproduct of gasoline there fore running cleaner (GREENER) and with far greater fuel economy.

Although the descriptions above contain many specificities, these should not be construed as limiting the scope of the embodiments but as merely providing illustrations of some of the presently preferred embodiments. For example, the vapor in ports, and vapor lines, can be of different sizes and shapes, as well as having electrical valves or solenoids to turn off or on or even meter a variable amount of vapors. The vapor injector system may have different components to pressurize the vapor line or lines, including but not limited to injector pulse time, and timing, etc.

Thus the scope of the embodiments will have a positive impact on our environment by using less gasoline. This will also be beneficial to our economy and the people of the world.

1. I claim, as an ASE Recertified Professional Master Automobile Technician, also Recertified as an Advance Level Specialist, although gasoline has been around for many years the vapors have never been used as fuel: Necessity is the mother of all inventions. Because of the rising cost of gasoline, I wanted to make lemonade out of lemons. So I figured out how to run gasoline powered engines with gasoline vapors.
Through the years gasoline has been enhanced with iso-octane or the aromatic hydrocarbons toluene and benzene to increase its octane rating. Some mixtures also contain significant quantities of ethanol as a partial alternative fuel.
Gasoline can be heated, cooled, altered, and or adjusted to get a more efficient vapor as fuel. No one can argue our use of gasoline is high and is not going to drastically change soon. So we should adopt my utility patent as soon as possible to have cleaner emissions, and conserve our resources world wide.
The research and development of this invention will be very easy to adapt to all gasoline powered engines. Including but not limited to Vehicle manufacturers, and small engine manufacturers, any gasoline powered engine worldwide, etc.
